(19) United States
(12) Patent Application Publication
(10) Pub. No.: US 2018/0305165 A1
(43) Pub. Date: Oct. 25, 2018

(54) DEVICE AND METHOD FOR CUTTING OFF AND PROVIDING A FILM PART UNIT FROM A FOOD PACKAGING FILM STRIP

(71) Applicant: CHOCAL ALUMINIUMVERPACKUNGEN GMBH, Schwäbisch Gmünd (DE)

(72) Inventors: Thomas Speck, Göggingen (DE); Joachim Scherr, Auenwald (DE); Konrad Bantleon, Gerstetten (DE)

(73) Assignee: CHOCAL ALUMINIUMVERPACKUNGEN GMBH, Schwäbisch Gmünd (DE)

(21) Appl. No.: 15/770,016

(22) PCT Filed: Oct. 21, 2016
(86) PCT No.: PCT/EP2016/075348

§ 371 Date: Apr. 20, 2018

(30) Foreign Application Priority Data
Oct. 23, 2015 (DE) 10 2015 220 738.2

(51) Int. Cl. B65H 35/02; B26F 1/44; B65H 29/24

(52) U.S. Cl. CPC B65H 35/02; B26F 1/44; B65H 2406/342; B26F 2001/4481; B65H 29/241

(57) ABSTRACT

The present invention proposes a device (1) that saves time and costs and is reliable and gentle on material for cutting off and providing a film part unit (20) from a food-packaging film strip (7), comprising a cutting station (2) which is adapted to intermittently cut off film part units (20) from a food-packaging film strip (7) which intermittently passes through the cutting station (2) in a conveying direction (5), characterized in that the cutting station (2) is adapted to pre-cut a film part unit (20) in one working step, where the film part unit (20) remains connected to the film strip (7), and to cut off from the film strip (7) a film part unit (20) that adjoins in the conveying direction (5) and has already been pre-cut in a preceding working step. The invention also relates to a corresponding method.

The present invention relates to a device for cutting off and providing a film part unit from a food-packaging film strip and a corresponding method according to the preambles of the independent claims.

It is known from practice to draw a strip of wound food-packaging film from a coil and feed it to a cutting station. In the cutting station, the end of the film strip is pushed, according to the length to be cut off, above an intended cutting point. The cutting point is there defined by a knife which provides a cut across the entire width of the film strip. The protruding portion of the film strip is subsequently cut off entirely by the knife at the cutting point. The resulting separate film part is then fed manually to a downstream working process.

In the known cutting process, every part is cut off individually from the film strip. Due to the very thin film thicknesses customary in the food-packaging sector, the film must be pushed into the cutting station in a manner requiring a complex design in order to prevent possible wrinkling when the film is moved. Nevertheless, the thin film can easily be damaged or form undesired wrinkles.

The present invention is based on the object of improving the known system and the corresponding method so that the film parts can be cut in a manner that saves time, costs and material, and is reliable and gentle on the material, while the film is least strained and remains smooth and no wrinkles or distortions arise.

The present invention satisfies the object stated with the features of the independent device claim.

By pulling the pre-cut film part unit in the conveying direction, so that a configuration of the cutting station, where a film part unit is pre-cut but still remains connected to the film strip and a previously pre-cut film part unit is cut off from the film strip in one working step, enables pulling the film strip and thus simultaneously the subsequent film in the conveying direction and thereby into the cutting station. Since the film is moved due to a tensile load in the conveying direction, it is ensured that the film remains smooth during the motion and does not deform undesirably. In addition, such pre-cutting and cutting off can be done in a time-efficient manner in one working step.

In a further embodiment, the cutting station can comprise a knife assembly defining the film part unit, where a severing knife arranged last in the conveying direction provides a cut that is transverse to the conveying direction and separates the film part unit from the film strip. The severing knife arranged last in the conveying direction ensures in a simple and reliable manner that a previously pre-cut film part unit is cut off from the film strip.

In a particular embodiment, the knife assembly can comprise at least one pre-cutting knife, in particular several pre-cutting knives spaced apart, extending from the severing knife against the conveying direction and/or at an angle to the conveying direction. The arrangement of such a pre-cutting knife makes it possible to divide the film part unit by way of the pre-cut into parts of desired dimensions, each having a cutting geometry matching the contour of the pre-cutting knife. The format of the parts is thus determined, at least to a certain degree, by the pre-cutting knife. The optional provision of several spaced pre-cutting knives makes it possible to pre-cut several parts at the same time, and also allows respectively adjoining parts to be pre-cut. The latter allows for optimal use of the area of the film strip since the entire film strip can be pre-cut into parts. This reduces film wastage.

In a further embodiment, the knife assembly can advantageously comprise a further severing knife which is arranged in the conveying direction upstream of the severing knife and provides a cut transverse to the conveying direction which completely severs at least one film-part of the film part unit from the film strip. Such an arrangement of a further severing knife makes it possible for the film part unit to have several film parts arranged consecutively in the conveying direction and thereby increases the number of film parts in the film part unit.

At least one further pre-cutting knife, in particular several further pre-cutting knives spaced apart, can extend in a particular manner from the further severing knife at an angle to and/or against the conveying direction. The arrangement of such a further pre-cutting knife makes it possible to divide the film part unit by pre-cutting it into further film parts having desired dimensions. The format of the film parts is thus determined, at least in part, by the pre-cutting knife. The optional provision of several spaced pre-cutting knives makes it possible to pre-cut several film parts at the same time, and also allows pre-cutting respectively adjoining further film parts. The latter enables optimal use of the area of the film strip, since the entire film strip can be pre-cut into film parts, each having cutting geometries adapted to the contour of the corresponding pre-cutting knives. This further reduces film wastage.

In a further embodiment, the cutting station can comprise a movable punch knife with the knife assembly. The punch knife makes it possible to quickly and reliably pre-cut the film part unit in one working step and to cut off the adjoining already pre-cut film part unit from the film strip.

Furthermore, it is proposed that the device comprises a movable transfer unit which is adapted to selectively couple to a pre-cut film part unit located in the cutting station and move it in the conveying direction, in particular, move it out of the cutting station. The pre-cut film part unit is moved reliably by the transfer unit from the cutting station in the conveying direction. The film is then conveyed under tensile load into the cutting station, which prevents wrinkling or the formation of folds in the film. The selective coupling allows controlling the point in time of coupling and decoupling. Optionally moving the film part unit out of the cutting station allows for a subsequent film part unit to be pre-cut in the cutting station and the pre-cut film part unit to be subsequently processed.

Furthermore, the transfer unit can be adapted to move a film part unit located in the cutting station with its connection point to the film strip to that location where the severing knife provides a cut transverse to the conveying direction. This ensures that the film part unit to be moved is cut off at the designated location from the film strip and also combines this function with pulling an uncut film part unit along into the cutting station and pulling a pre-cut film part unit out of the cutting station.

The transfer unit can advantageously be adapted to couple and/or decouple the film part unit only on one side of the film. Coupling and/or decoupling the film part unit on only one side of the film allows for the transfer unit needing to approach only from one direction for coupling/decoupling the film part unit, which has the effect of a simpler and more compact design of the cutting station and the transfer unit. In addition, the contact between the film part unit and the transfer unit is reduced to one side of the film part unit, which facilitates both coupling and decoupling of the film part unit.

In one particular embodiment, the transfer unit can comprise a suction device, in particular a suction plate. The suction device reduces the risk of damaging the film part unit during coupling/decoupling and during movement with the transfer unit. The optional embodiment in the form of a suction plate makes it possible to move the film part unit in a flat and/or planar position and shape.

In a further embodiment, the device can comprise a film conveyor unit which can selectively couple and hold a partial section of the film strip located in the conveying direction upstream of the cutting station and/or move it in the conveying direction. As a result, the film to be fed is supported by the film conveyor unit and the force acting upon the connection point between the pre-cut film part unit and the remaining film strip is reduced. This prevents unintentional damage or premature tearing of the film part unit at the connection point, in particular when narrow connection points are provided. Selectively coupling and holding can also reduce a potentially adverse effect of the cutting operation on the portions of the film strip that are upstream of the film conveyor unit.

The film conveyor unit and the transfer unit can advantageously be connected to one another by way of a movable, rigid structure, in particular by way of a carriage. This allows the movements of the film conveyor unit and the transfer unit to be coupled to one another, so that both units can be moved in only one motion. During movement of the two units, the rigid structure further ensures that their distance remains the same, so as not to damage or collapse the film. The optional version with a carriage allows for a simple and reliable connection of the film conveyor unit to the transfer unit.

The film conveyor unit can preferably comprise a clamping device which can selectively clamp the partial section of the film strip on both sides of the film strip. The clamping device allows for reliable and rapid coupling and holding and/or movement of the partial section of the film strip. Clamping the film strip from both sides increases the reliability of force transmission from the film conveyor unit to the film strip and reduces the risk of damaging the film at the clamping point. Furthermore, the two-sided clamping especially reduces possible adverse effects of the cutting process on portions of the film strip located upstream of the film conveyor unit.

The present invention further satisfies the object stated with the features of the independent method claim.

Pre-cutting a film part unit, while it remains connected to the film strip, and cutting off a film part unit, adjoining in the conveying direction and pre-cut in a preceding working step, from the film strip during the same working step allows for the remaining film strip to also be pulled for pre-cutting in the conveying direction in that the pre-cut film part unit is pulled in the conveying direction. Since the film is moved only due to a tensile load in the conveying direction, it is ensured that the film remains smooth during the motion and does not collapse or deform undesirably. Furthermore, more elaborate advancing of the film for pre-cutting is no longer necessary. In addition, pre-cutting and cutting off can be done in a time-efficient manner in one working step.

In a further embodiment, the film part unit can be pre-cut into at least one film part that is connected to the film strip and at least one film part that is completely cut off from the film strip. This increases the number of cut film parts in the film part unit for every working step and thus the yield of film parts per unit time.

Furthermore, the film part unit can be pre-cut with a knife assembly and the adjacent film part unit can also be cut off with this knife assembly, in particular with a punch knife, which is comprised by the knife assembly. Pre-cutting and cutting the film part unit off with the same knife assembly makes it easy to perform both cutting operations in the same working step.

The pre-cut film part unit can advantageously be moved with its connection point to the film strip to a position in the conveying direction at which it is cut off from the film strip during a pre-cutting step of a trailing film part unit. This ensures that the film part unit is cut off from the film strip at a location exactly designated for this.

In a further embodiment, the pre-cut film part unit can be selectively coupled by a transfer unit, in particular by a movable suction device, especially by a movable suction plate, and moved in the conveying direction. The film part unit is reliably moved by the transfer unit in the conveying direction. By selectively coupling the film part unit and moving in the conveying direction, the film is safely and reliably moved under tension to the pre-cutting step, which prevents wrinkling or the formation of folds in the film. The optional coupling and movement of the film by way of a movable suction device reduces the risk of damage to the film part unit during coupling and movement with the transfer unit. The optional coupling and movement of the film part unit by way of a suction plate allows for the film part unit to move in a flat and/or planar position and shape.

Furthermore, the film part unit cut off from the film strip can be moved to a downstream processing station. This enables automated, fast and direct processing of the film part unit cut off.

In a further variant of the invention, a partial section of the film strip, which in the conveying direction is upstream of the pre-cut film part unit, can be moved simultaneously with the pre-cut film part unit in the conveying direction, in particular at a uniform distance from the pre-cut film part unit. As a result, the film to be fed is supported in its motion and the force acting upon the connection point between the pre-cut film part unit and the remaining film strip is reduced. This prevents unintentional damage or premature tearing of the film part unit at the connection point, in particular when narrow connection points are provided. The optionally movement at a uniform distance further reduces unintentional damage or collapse of the film as it moves.

For better understanding of the invention, a possible embodiment of the invention shall be explained in more detail with reference to the figures described below, where

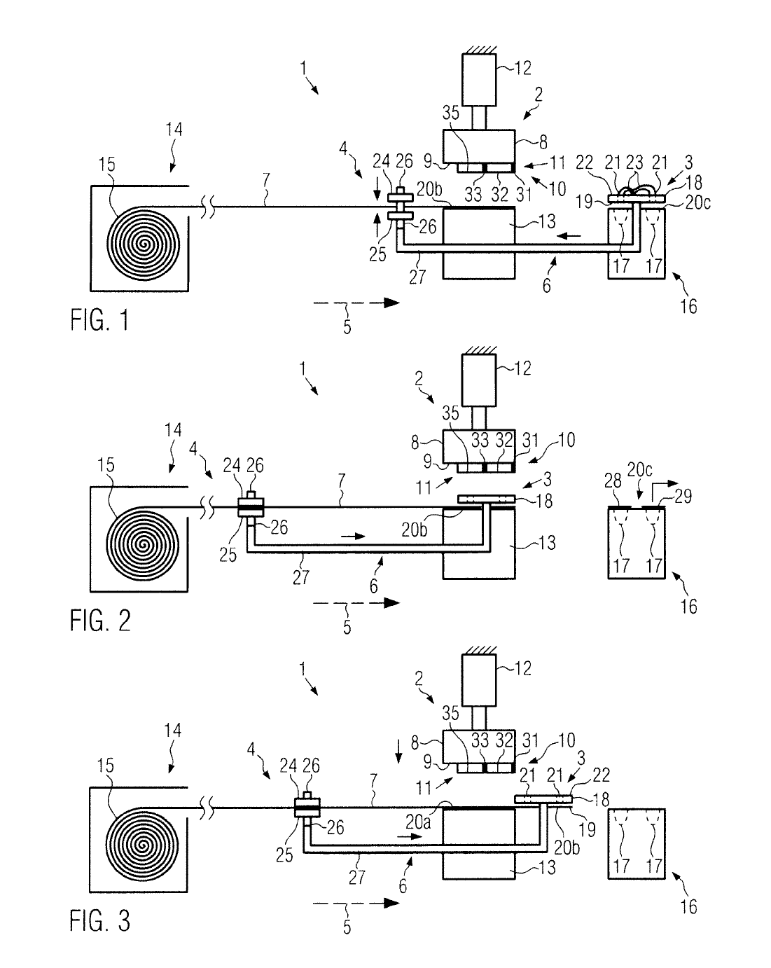

FIG. 1 shows a schematic lateral view of a device according to the invention in a state in which a film part unit is located already pre-cut in a cutting station;

FIG. 2 shows the schematic view of FIG. 1 in a state in which a transfer unit has moved into the cutting station and couples the pre-cut film part unit;

FIG. 3 shows the schematic view of FIG. 2 in a state in which the transfer unit has moved the pre-cut film part unit, still connected to the film strip, out of the cutting station to a defined position;

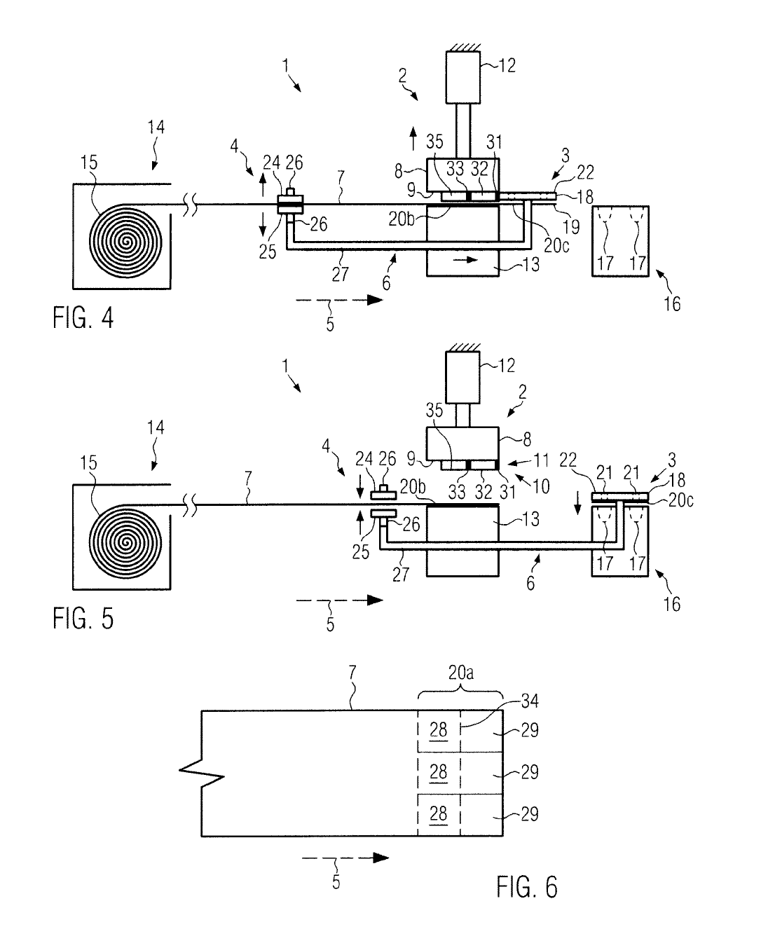

FIG. 4 shows the schematic view of FIG. 3 in a state in which the cutting station has cut off the already pre-cut film part unit from the film strip and has pre-cut a subsequent film part unit in the same working step;

FIG. 5 shows the schematic view of FIG. 4 in a state in which the transfer unit has conveyed the cut-off film part unit to a downstream processing station;

FIG. 6 shows a schematic top view of a film part unit, not yet pre-cut, with film parts still connected;

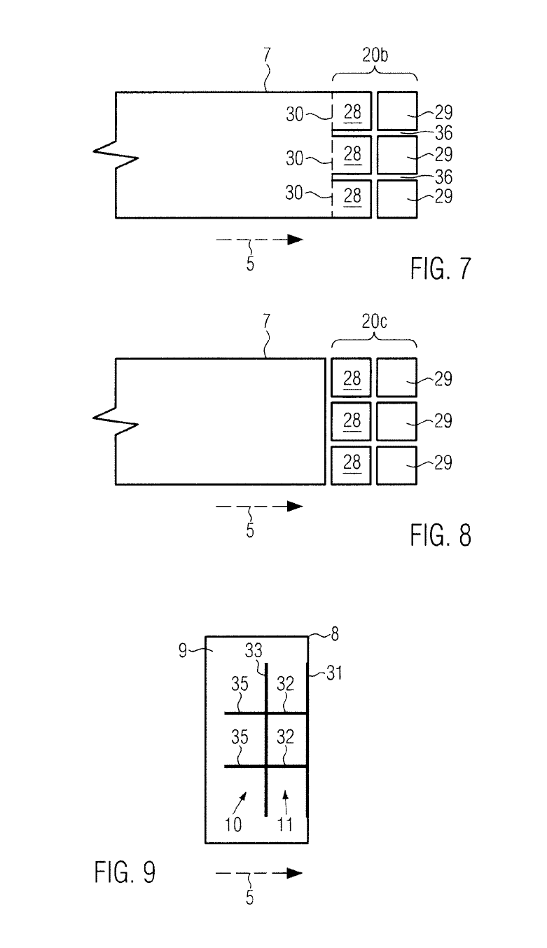

FIG. 7 shows a schematic top view of a pre-cut film part unit with partially separated film parts;

FIG. 8 shows a schematic top view of a film part unit that is entirely cut off from the film strip with the film parts separated;

FIG. 9 shows a schematic top view of the cutting side of a punch knife;

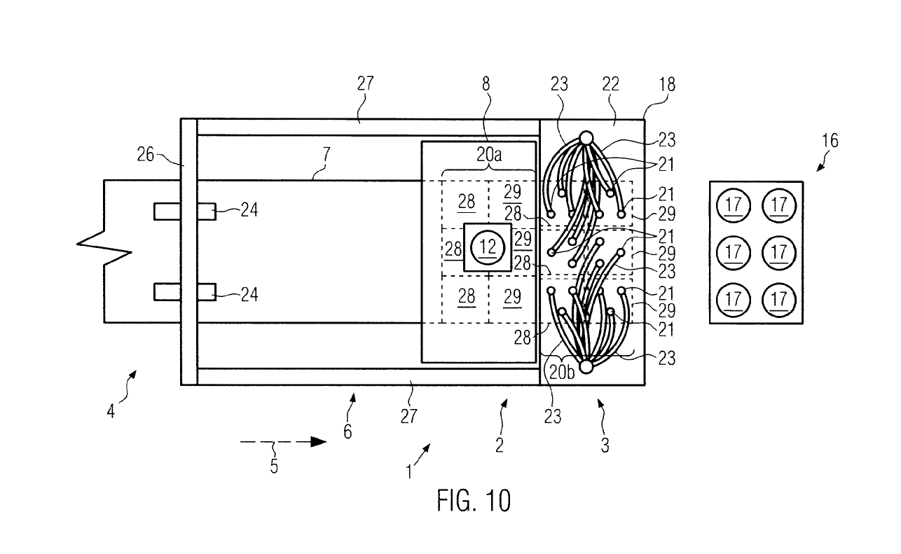

FIG. 10 shows a schematic view from above of the device shown in FIG. 3.

The configuration of the device according to the invention shall first be described with reference to FIGS. 1 and 6 to 10.

As can be seen in FIG. 1, device 1 comprises a cutting station 2, a transfer unit 3 and a film conveyor unit 4.

Transfer unit 3 and film conveyor unit 4 are positioned on a carriage 6 which moves to and fro along conveying direction 5 and pull a film strip 7 intermittently in conveying direction 5 through cutting station 2. Film strip 7 extends in the region of cutting station 2 in a taut and wrinkle-free manner, approximately along conveying direction 5.

Conveying direction 5 of film 7 is drawn as a dashed arrow in all figures.

Cutting station 2 comprises a punch 8 that moves to and fro linearly and perpendicularly to conveying direction 5 between an open retracted position and a closed cutting position and that comprises a punch knife 10 with a knife assembly 11 on a side 9 facing film strip 7. Punch 8 is driven by a linear actuator 12. Cutting station 2 further comprises a punching table 13 which is arranged opposite punch 8, so that film strip 7 runs between punch 8 and punching table 13. During operation, film strip 7 is pulled intermittently by transfer unit 3 over punching table 13.

Located in the conveying direction 5 upstream of cutting station 2 is a film supply unit 14 which rotatably supports film strip 7 in the form of a peelable film coil 15. Film coil 15 can be rotatably driven and/or braked to assist the peeling operation.

Disposed in conveying direction 5 downstream of cutting station 2 is a processing station 16 which comprises hollow molds 17 for molding packaging halves for hollow figurines.

Transfer unit 3 comprises a suction plate 18. Suction plate 18 is planar on its underside 19 facing film strip 7 and on its upper side 22 and in the open position of punch 8 can retract into pre-cutting unit 2 in order to there suction a pre-cut film part unit 20b by way of negative pressure, pull it out in conveying direction 5 from cutting station 2 and finally deposit it in processing station 16.

FIG. 10 shows suction plate 18 with a suctioned pre-cut film part unit 20b outside of cutting station 2. Suction plate 18 is provided with through holes 21 at locations at which during positioning in cutting station 2 on the underside 19 thereof individual film parts 28, 29 (hereinafter referred to as “parts”) of pre-cut film part unit 20b are located, so that the application of negative pressure from upper side 22 of suction plate 18 causes a negative pressure at underside 19 of suction plate 18. Parts 28, 29 of film part unit 20b can therefore be selectively coupled by planar underside 19 along the entire surface of their upper side.

Located on upper side 22 of suction plate 18 are negative pressure lines 23 which are connected to through holes 21. For the sake of clarity, negative pressure lines 23 are shown schematically only in FIG. 10, where only some of them are provided with reference numerals. They are controllably connected to a negative pressure reservoir which is not shown for reasons of clarity. For ease of understanding, pre-cut film part unit 20b suctioned onto underside 19 in FIG. 10 is shown with its parts 28, 29 in dashed lines. The same applies to a film part unit 20a—still uncut—below punch 8.

As can be seen in FIG. 10, suction plate 18 is attached to one end of movable carriage 6. Compared to film strip 7, suction plate 18 is disposed in the vertical direction on the side of punch 8 and spans film strip 7 like a bridge transverse to conveying direction 5. Transfer unit 3 can therefore move to and fro in a region above film strip 7 and between cutting station 2 and processing station 16.

As can be seen from FIG. 10 in conjunction with FIG. 1, film conveyor unit 4 there has four clamping jaws 24, 25, where two clamping jaws 24, 25 are disposed opposite each other on either side of film strip 7. Clamping jaws 24 respectively located on one film side are connected to each other via a cross member 26 of carriage 6 which stretches across the entire width of film strip 7 transverse to conveying direction 5. Clamping jaws 24, 25 are controllably movable between a state that is closed, thereby clamping film strip 7, and a state that is open, thereby releasing film strip 7.

Transfer unit 3 and film conveyor unit 4 are connected rigidly and at a defined distance from each other by way of two longitudinal members 27 of carriage 6 which extend parallel to each other and parallel to conveying direction 5. The respective ends of longitudinal members 27 are connected to each other by two cross members 26 as well as suction plate 18. Suction plate 18 is disposed movable in the vertical direction, i.e. perpendicular to conveying direction 5, in a manner controllable by actuators, not shown, on longitudinal members 27. Carriage 6 is driven by a controllable movement unit, not shown, and moved to and fro in conveying direction 5.

FIG. 6 shows a film part unit 20a in a state where it is still uncut. The points where punch knife 10 provides cuts are shown in dashed lines. The total of presently 6 rectangular parts 28, 29 of film part unit 20a are arranged in the array 3 x 2 and share one end of film strip 7 completely among each other. The number of parts 28, 29 and their arrangement in conveying direction 5 and transverse to conveying direction 5 can be varied at random, as necessary, by way of the configuration of knife assembly 11, as shall be explained further on.

FIG. 7 shows a film part unit 20b in the pre-cut state. Pre-cut film part unit 20b comprises six parts 28, 29, where three parts 29 are already completely cut off from remaining film strip 7 and from each other, and three further parts 28 are respectively still connected to film strip 7 at a side edge 30. Side edges 30 represent the connection point of pre-cut film part unit 20b to remaining film strip 7. Parts 29 completely cut off from film strip 7 are arranged in one row next to one another across the entire width of film strip 7 at the point of film strip 7 which in conveying direction 5 is the outermost one.

FIG. 8 shows a film part unit 20c in its fully cut off state. All six parts 28, 29 are completely cut off from adjoining parts and from remaining film strip 7.

FIG. 9 shows punch knife 10 of punch 8 with knife assembly 11.

Knife assembly 11 comprises a severing knife 31 which in conveying direction 5 is arranged last and provides a cut that is transverse to conveying direction 5 and that separates pre-cut film part unit 20b at connection point 30 of film strip 7 when moved out of the cutting station. Severing knife 31 is there an elongate blade which extends perpendicular to conveying direction 5 and plumb-vertical to the film strip end located in cutting station 2.

Knife assembly 11 further comprises two spaced blade-like pre-cutting knives 32 which extend from severing knife 31 against conveying direction 5 and in parallel thereto.

Knife assembly 11 also comprises a further blade-like severing knife 33 which is arranged in conveying direction 5 upstream of severing knife 31 and also provides a cut transverse to conveying direction 5 across the entire width of film strip 7. Further severing knife 33 extends parallel to severing knife 31 and perpendicular to pre-cutting knives 32. The cut provided by this further severing knife 33 completely separates parts 29 shown in FIG. 6 from film strip 7 at dashed line 34.

Knife assembly 11 comprises two further blade-like pre-cutting knives 35 which extend parallel to and against conveying direction 5 from further severing knife 33 and there continue pre-cutting knives 32. The common length of pre-cutting knives 32, 35 corresponds to the length of cuts 36 in FIG. 7 in conveying direction 5 running parallel to the conveying direction.

When comparing knife assembly 11 shown in FIG. 9 with film part unit 20a shown in dashed lines in FIG. 6, it becomes clear that knife assembly 11 defines the format of film part unit 20a. Film part unit 20a is separated by knife assembly 11 into individual parts 28, 29, where all parts 28, 29 can be used in the downstream treatment processes.

The mode of operation of device 1 according to the invention and the method according to the invention shall be explained in more detail with reference to FIGS. 1 to 5. FIGS. 1 to 5 schematically show device 1 in temporally successive working steps. Motions of individual members, which are performed in a directly subsequent working step, are indicated by arrows for better understanding.

Clamping jaws 24, 25 are open in the state shown in FIG. 1. Located on punching table 13 is a pre-cut film part unit 20b in a state as shown in FIG. 7.

Suction plate 18 is located in conveying direction 5 at the level of hollow molds 17. Individual parts 28, 29 of a cut off film part unit 20c were just placed on hollow molds 17 of processing station 16 due to the interruption of the negative pressure at suction plate 18 and suction plate 18 has already traveled some distance vertically upwardly away from hollow molds 17. Carriage 6 with suction plate 18 and clamping jaws 24, 25 is in conveying direction 5 in its maximum position. Punch 8 is in its retracted position.

Carriage 6 subsequently drives suction plate 18 and film conveyor unit 4 against conveying direction 5 until suction plate 18 enters cutting station 2 in the corridor formed between punch 8 and punching table 13 and is stopped above pre-cut film part unit 20b. Carriage 6 with suction plate 18 and clamping jaws 24, 25 is against conveying direction 5 in its maximum position. Punch 8 continues to be in its retracted position.

Suction plate 18 now moves vertically onto pre-cut film part unit 20b until underside 19 is in planar contact with film part unit 20b. Film part unit 20b is now suctioned by negative pressure and thereby coupled on one side to suction plate 18 in a planar manner. Both parts 28 that are still connected to film strip 7 as well as parts 29 that are already cut off from film strip 7 are coupled by suction plate 18.

Shortly after suction plate 18 has coupled to film part unit 20b, oppositely disposed clamping jaws 24, 25 also move toward each other and clamp a partial section of film strip 7 that is in conveying direction 5 upstream of cutting station 2. This state is shown in FIG. 2.

Carriage 6 subsequently moves suction plate 18 with suctioned and pre-cut film part unit 20b in conveying direction 5 to a defined position, so that connection point 30 is aligned with severing knife 31 and can be cut off by the latter in a punching operation. In the motion of the carriage, the pulling motion of suction plate 18 is transferred to the remaining film strip 7 due to connection point 30 still existing between pre-cut film part unit 20b and remaining film strip 7, and remaining film strip 7 is thereby also pulled in conveying direction 5 and a portion thereof is conveyed into cutting station 2 and comes to rest as a pre-cut film part unit 20a below punch knife 10 on punching table 13.

Film conveyor unit 4 with closed clamping jaws 24, 25 there supports film strip 7 in its motion in conveying direction 5 and thus limits the tensile force acting on connecting point 30. Pre-cut film part unit 20b unintentionally tearing off at connection point 30 during the pull is thus prevented in the case of a long and heavy film web 7 and/or a film coil 15 which is hard to unroll.

Parts 28, 29 deposited in processing station 16 in the meantime have been formed with a forming die, not shown, to hollow half shells, and are then transported via a gripper, also not shown, to a subsequent working step.

FIG. 3 shows pre-cut film part unit 20b with suction plate 18 and connection point 30 in the position described above.

Located beneath punch 8 is now a film part unit 20a that is still uncut, as shown in FIG. 6.

Punch 8 now moves with knife assembly 11 toward punching table 13, thereby transferring its knife assembly 11 in the form of cuts onto film strip 7. Closed clamping jaws 24, 25 avoid that the motion of punch knife 10 is adversely transferred to portions of film strip 7 that are in conveying direction 5 located upstream of clamping jaws 24, 25.

FIG. 4 shows punch 8 in its fully extended position in which punch knife 10 has penetrated film strip 7 at locations determined by knife assembly 11. In a subsequent working step, punch 8 moves back to its retracted position and clamping jaws 24, 25 open.

Film part unit 20b on punching table 13 is now pre-cut, as shown in FIG. 7. Pre-cutting within the meaning of the invention is understood to be any kind of separation, including only the partial separation of film/film portions. Film part unit 20c, which is coupled to suction plate 18, is now completely separated from film strip 7 and is present in the form shown in FIG. 8, in which all parts 28, 29 are completely separated. Pre-cutting a film part unit 20a that is not yet pre-cut and cutting off an adjoining already pre-cut film part unit 20b is therefore carried out in one cutting operation. These cutting operations preferably occur simultaneously.

Clamping jaws 24, 25 subsequently open.

Carriage 6, with open clamping jaws 24, 25 and parts 28, 29 coupled to suction plate 18, now moves in conveying direction 5 until suction plate 18 is located above hollow molds 17.

FIG. 5 shows how suction plate 18, there still coupled to film part unit 20c that is entirely cut off, is located above hollow molds 17 in processing station 16.

In a subsequent working step, suction plate 18 is moved with film part unit 20c toward hollow molds 17 and the negative pressure applied to suction plate 18 is terminated. As a result, film part unit 20c, with its individual parts 28, 29 completely separated from each other, is placed accordingly onto hollow molds 17.

The subsequent working step is similar to the working step previously described for FIG. 1.

According to further possible embodiments, the food-packaging film cut off and provided according to the present invention can be a metal film, in particular an aluminum film, a plastic film or a film as an aluminum-plastic composite.

In further possible embodiments, the food-packaging film cut off and provided according to the invention can be a film for packaging chocolate, preferably a film for packaging hollow chocolate figurines.

According to further possible embodiments, the food-packaging film cut off and provided according to the invention can have a film thickness in the range from 5 μm to 100 μm, in particular a thickness in the range from 10 μm to 50 μm, especially a thickness in the range from 15 μm to 30 μm.

1. Device (1) for cutting off and providing a film part unit (20a, 20c) from a food-packaging film strip (7), comprising
a cutting station (2) which is adapted to intermittently cut off film part units (20a, 20c) from a film strip (7) which intermittently passes through said cutting station (2) in a conveying direction (5),
characterized in that
said cutting station (2) is adapted to pre-cut a film part unit (20a) in one working step, where said film part unit (20a) remains connected to said film strip (7), and to cut off from said film strip (7) a film part unit (20b) that adjoins in the conveying direction (5) and has already been pre-cut in a preceding working step.

2. Device (1) according to claim 1, characterized in that
said cutting station (2) comprises a knife assembly (11) defining said film part unit (20a, 20b, 20c), where a severing knife (31) in said conveying direction (5) arranged last provides a cut transverse to said conveying direction (5) which separates said film part unit (20b) from said film strip (7).

3. Device (1) according to claim 2, characterized in that
said knife assembly (11) comprises at least one pre-cutting knife (32), in particular several pre-cutting knives (32) spaced apart, extending from said severing knife (31) against said conveying direction (5) and/or at an angle to said conveying direction (5).

4. Device (1) according to claim 2 or 3, characterized in that
said knife assembly (11) comprises a further severing knife (33) which is arranged in said conveying direction (5) upstream of said severing knife (31) and provides a cut transverse to said conveying direction which completely cuts off at least one film part (29) of said film part unit (20a) from said film strip (7).

5. Device (1) according to claim 4, characterized in that at least one further pre-cutting knife (35), in particular several further pre-cutting knives (35) spaced apart, extend from said further severing knife (33) at an angle to and/or against said conveying direction (5).

6. Device (1) according to one of the claims 2 to 5, characterized in that,
said cutting station (2) comprises a movable punch knife (10) with said knife assembly (11).

7. Device (1) according to one of the preceding claims, characterized in that
said device (1) comprises a movable transfer unit (3) which is adapted to selectively couple to a pre-cut film part unit (20b) located in said cutting station (2) and move it in said conveying direction (5), in particular, to move it out of said cutting station (2).

8. Device (1) according to claim 7 and to the extent depending on claim 2, characterized in that
said transfer unit (3) is adapted to move a film part unit (20b) located in said cutting station (2) with its connection point (30) to said film strip (7) to that location where said severing knife (31) provides a cut transverse to said conveying direction (5).

9. Device (1) according to claim 7 or 8, characterized in that
said transfer unit (3) is adapted to couple and/or decouple said film part unit (20b, 20c) only on one side of the film.

10. Device (1) according to one of the claims 7 to 9, characterized in that,
said transfer unit (3) comprises a suction device, in particular a suction plate (18).

11. Device (1) according to one of the preceding claims, characterized in that
said device (1) comprises a film conveyor unit (4) which can selectively couple and hold a partial section of said film strip (7) in said conveying direction (5) located upstream of said cutting station (2) and/or move it in said conveying direction (5).

12. Device (1) according to claim 11, characterized in that said film conveyor unit (4) and said transfer unit (3) are connected to one another by way of a movable rigid structure, in particular by way of a carriage (6).

13. Device (1) according to one of the claims 11 to 12, characterized in that,
said film conveyor unit (4) comprises a clamping device (24, 25) which can selectively clamp said partial section of said film strip (7) on both sides of said film strip (7).

14. Device for cutting off and providing a film part unit (20a, 20c) from a food-packaging film strip (7), where
film part units (20a, 20c) are intermittently cut off from a film strip (7) which runs intermittently in a conveying direction (5),
characterized in that
said film part unit (20a) is pre-cut in one working step, where it remains connected to said film strip (7), and a film part unit (20b) adjoining in said conveying direction (5) and already pre-cut in a preceding working step is cut off in the same working step from said film strip (7).

15. Method according to claim 14, characterized in that
said film part unit (20a) is pre-cut into at least one film part (28) that is connected to said film strip (7) and at least one film part (29) that is completely cut off from said film strip (7).

16. Method according to claim 14 or 15, characterized in that
said film part unit (20a) is pre-cut with a knife assembly (11) and said adjacent film part unit (20b) is also cut off with said knife assembly (11), in particular with a punch knife (10) which is comprised by said knife assembly (11).

17. Method according to one of the claims 14 to 16, characterized in that said pre-cut film part unit (20b) is moved with its connection point (30) to said film strip (7) to a position in said conveying direction (5) at which it is cut off from said film strip (7) during a pre-cutting step of a trailing film part unit (20a).

18. Method according to one of the claims 14 to 17, characterized in that
said pre-cut film part unit (20b) is selectively coupled by a transfer unit (3), in particular by a movable suction device, especially by a movable suction plate (18), and moved in said conveying direction (5).

19. Method according to one of the claims 14 to 18, characterized in that
said film part unit (20c) cut off from said film strip (7) is moved to a downstream processing station (16).

20. Method according to one of the claims 14 to 19, characterized in that
a partial section of said film strip (7), which in said conveying direction (5) is upstream of said pre-cut film part unit (20b), is moved simultaneously with said pre-cut film part unit (20b) in said conveying direction (5), in particular at a uniform distance from said pre-cut film part unit (20b).
